(19) United States
(12) Patent Application Publication
(10) Pub. No.: US 2021/0204708 A1
(43) Pub. Date: Jul. 8, 2021

(54) BED AND SMART ELECTRONIC MODULE FOR A BED

(71) Applicant: Dux Interiors, Inc., New York, NY (US)

(72) Inventors: Wayne Ludlum, Huntington Beach, CA (US); Ed Curry, Pleasantville, NY (US)

(21) Appl. No.: 17/139,321

(22) Filed: Dec. 31, 2020

Related U.S. Application Data
(60) Provisional application No. 62/956,896, filed on Jan. 3, 2020.

(51) Int. Cl. A47C 21/00; H04R 1/02; H04R 7/12; H04R 1/08; H04R 1/40; H04R 3/00; G06F 3/16; G05B 15/02

(52) U.S. Cl. CPC A47C 21/003; H04R 1/025; H04R 7/12; H04R 1/08; H04R 2201/401; H04R 1/406; H04R 3/005; G06F 3/167; G05B 15/02; H04R 1/023

(57) ABSTRACT

A bed includes a frame having a plurality of rails and a plurality of legs. A pair of rails of the plurality of rails form a channel therebetween, and the plurality of legs positions the plurality of rails above a floor surface. An electronic module is coupled to the frame. The electronic module includes a housing configured to be disposed at least partially within the channel and supported by the pair of rails. A pair of speakers disposed within the housing, and each of the pair of speakers includes a cone that has a concave surface that opens in a direction towards the floor surface. One or more microphones supported on an exterior of the housing, the one or more microphones are oriented in a direction away from the pair of speakers.

### CROSS-REFERENCE TO RELATED APPLICATIONS

This application claims priority to and the benefit of U.S. Provisional Application No. 62/956,896, filed Jan. 3, 2020, the disclosure of which is hereby incorporated by reference herein in its entirety.

### INTRODUCTION

Beds are a piece of furniture that are used as a place to sleep or relax and generally include a soft, cushioned mattress on a bed frame. Generally, beds are separate from home electronics that can be found in a bedroom, such as, alarm clocks, audio speakers, televisions, etc. Smart speakers that are capable of voice interaction, which facilitate music playback, setting alarms, providing weather and news, and control of connected devices are becoming more popular and are often placed in bedrooms. These smart speakers, however, are also separate from the bed. It is desirable to incorporate smart speakers into a bed.

### BED AND SMART ELECTRONIC MODULE FOR A BED

A bed and a smart electronic module for a bed are described herein. The electronic module is configured to be mounted within the bed and includes a pair of speakers and a plurality of microphones so that a voice-controlled intelligent virtual personal assistant is enabled. By mounting the electronic module within the bed, the module is hidden within the bed and the bedroom is free from smart speakers being located around the room. Additionally, the bed enhances performance of the electronic module so that the electronic module can have a compact design. The electronic module is positioned underneath a head of the bed and has a pair of mid-high frequency speakers disposed within a closed back cabinet. The speakers are pointed towards a floor surface that the bed is positioned upon. A plurality microphones that pick up sound and enable voice activated control of the electronic module are also included on the electronic module. The microphones are far-field microphones with beam forming technology so that the electronic module can pick up sounds from across a room while music is playing from the speakers. The microphones are positioned on the electronic module to be pointed away from the speakers and in a direction towards a foot of the bed and along the floor surface. By pointing the speakers and the microphones in different directions, the microphones can more easily pick up voice commands from the user without interference from the sounds generated by the speakers. The electronic module described herein is more than merely mounting speakers and microphones to a bed. The position and orientation of the speakers and microphones on the electronic module are designed so as to increase performance and enable a system that performs as if it is sitting on a nightstand right next to the bed.

These and various other features as well as advantages which characterize the beds and smart electronic modules described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure in the written description and claims hereof, as well as the appended drawings.

It is to be understood that both the foregoing introduction and the following detailed description are exemplary and explanatory and are intended to provide further explanation of the invention as claimed.

### BRIEF DESCRIPTION OF THE DRAWINGS

The following drawing figures, which form a part of this application, are illustrative of described technology and are not meant to limit the scope of the technology as claimed in any manner, which scope shall be based on the claims appended hereto.

FIG. 1 is a partial side elevation view of a bed with an exemplary smart electronic module.

FIG. 2 is a perspective view of the smart electronic module.

FIG. 3 is an exploded perspective view of the smart electronic module.

FIG. 4 is a longitudinal cross-sectional view of the smart electronic module.

FIG. 5 is a transverse cross-sectional view of the smart electronic module.

FIG. 6 is a vertical end view of the smart electronic module.

FIG. 7 is a perspective view of an exemplary microphone module of the smart electronic module.

FIG. 8 is a vertical end view of the microphone module.

FIG. 9 is a schematic view of the smart electronic module coupled to other furniture pieces.

### DETAILED DESCRIPTION

This disclosure describes a bed and a smart electronic module for a bed. The electronic module is configured to be mounted within the bed and includes a pair of speakers and a plurality of microphones so that a voice-controlled intelligent virtual personal assistant is enabled. In an aspect, the virtual assistant is Alexa developed by Amazon. As such, the bed can be used for voice interaction and play music, set alarms, provide weather and news, etc. Additionally, the bed itself can be used in a home automation system and be used to control other connected devices, such as, but not limited to, thermostat(s), shades, fire & CO₂ alarm(s), lighting systems, door and/or window locks, etc. By mounting the electronic module within the bed, the module is hidden within the bed and the bedroom is free from smart speakers being located around the room. Additionally, the bed enhances performance of the electronic module to so that the electronic module can have a compact design.

The electronic module is positioned underneath a head of the bed and has a pair of mid-high frequency speakers disposed within a closed back cabinet. The speakers are pointed towards a floor surface that the bed is positioned upon. The bed itself creates a sub-woofer effect for mid-low frequencies so that the bed and electronic module forms a system that is capable of generating a full range of audio frequencies. Furthermore, the pair of speakers can be used to generate stereophonic sound with left and right speakers and create the impression of sound emanating from various directions from within the room. In an aspect, the speakers are angled about 15° to the right and left, respectively, so as to enable increased sound performance. Additionally, by angling the speakers, the floor surface can be used to direct the sound generated by the speakers positioned underneath the bed towards areas outside of the bed.

A plurality microphones that pick up sound and enable voice activated control of the electronic module are also included on the electronic module. The microphones are far-field microphones with beam forming technology so that the electronic module can pick up sounds from across a room while music is playing from the speakers. The microphones are positioned on the electronic module to be pointed away from the speakers and in a direction towards a foot of the bed and along the floor surface. By pointing the speakers and the microphones in different directions, the microphones can more easily pick up voice commands from the user without interference from the sounds generated by the speakers. Furthermore, by orienting the microphones towards the foot of the bed, the user can be in many locations around the bed while still being able to use the electronic module.

The electronic module described herein is more than merely mounting speakers and microphones to a bed. This is because mounting speakers and microphones underneath a bed can generate performance problems, since the sound and voice pick up components are oriented towards the floor surface, which is undesirable. Instead, the position and orientation of the speakers and microphones on the electronic module described herein are designed so as to increase performance and enable a system that performs as if it is sitting on a nightstand right next to the bed.

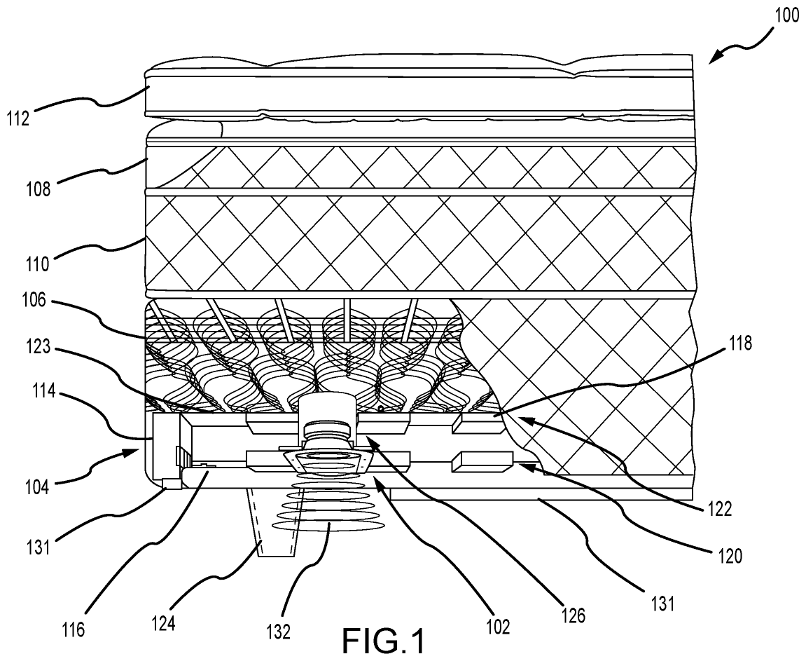

FIG. 1 is a partial side elevation view of a bed 100 with an exemplary smart electronic module 102. In the example, the bed 100 is an internal frame mattress that includes a frame 104 configured to support one or more layers of continuous coil springs. As illustrated in FIG. 1, the bed 100 includes three layers of springs. A bottom spring layer 106 is supported directly on the frame 104, a top spring layer 108, and a middle spring layer 110 disposed between the bottom spring layer 106 and the top spring layer 108. In one example, the top spring layer 108 may include two or more interchangeable spring cassettes that enable the firmness of the bed 100 to be customized as required or desired. Above the top spring layer 108, the bed may also include a removable top pad 112 that adds extra softness and cushioning.

The frame 104 includes a head rail 114, an opposite foot rail (not shown), and a pair of side beams 116. The head rail 114, foot rail, and side beams 116 form a substantially rectangle like shape. A plurality of intermediate rails 118 span between the side beams 116 and are spaced between the head rail 114 and the foot rail. In the example, there are two stacked rows 120, 122 of the intermediate rails 118. The frame 104 provides support for the spring layers described above. A plurality of legs 124 are coupled to the frame 104 so as to position the frame 104 above a floor surface (not shown). In an aspect, the legs 124 are threadingly coupled to the frame 104 so that the legs 124 can be replaced as required or desired. In the example, the bed 100 may be a DUX® bed. It should be appreciated, however, that the bed 100 can have any other structural design that enables the electronic module 102 to function as described herein. Furthermore, the electronic module 102 may be coupled to an existing bed 100 as a retrofit component and enable any type bed to become a smart bed with virtual assistant capabilities.

In the example, the frame 104 and the rails 118 are formed from wood. Wood generates a warmer feel to the generated sound from the electronic module 102. The wood frame 104 and rails 118 can absorb energy generated from the electronic module 102 and reduce echoes, ambient noises, and vibrations. In other examples, the frame 104 and the rails 118 can be formed from plastic, metal, or any other material as required or desired. In some example, the frame 104 may be formed from a different material than the rails 118.

A pair of intermediate rails 118 form a channel 126 therebetween. The channel 126 extends between both rows 120, 122 of the rails 118. The electronic module 102 is sized and shaped to be supported within the channel 126 and at least partially between the pair of intermediate rails 118. The electronic module 102 also extends between both of the two rows 120, 122 of rails 118. In an aspect, the rails 118 are constructed out of a wood or wood-based material. Additionally, a felt material layer 123 is disposed between the bottom spring layer 106 and the rails 118. The felt material layer 123 can generate a buffer for sound to resonate within the frame 104 and generate a warmer feel to the generated sound from the electronic module 102. As such, the structure of the frame 104 forms a cavity that creates a sub-woofer effect for the electronic module 102 and the ability to generate mid to low range sound frequencies.

The smart electronic module 102 is configured to enable a voice-controlled intelligent virtual personal assistant. This allows the bed 100 itself to be capable of voice interaction, for example, allow music playback, stetting alarms, providing news and weather, etc. for a user. Additionally, the bed 100 itself can be used in a home automation system and be used to control other connected devices, such as, but not limited to, thermostat(s), shades, fire & CO2 alarm(s), lighting systems, door and/or window locks, etc. In an aspect, the virtual assistant is Alexa developed by Amazon. It should be appreciated, however, that the electronic module 102 can enable operation of any other virtual assistant as required or desired, such as, but not limited to, Google Assistant developed by Google, Siri developed by Apple, or Cortana developed by Microsoft.

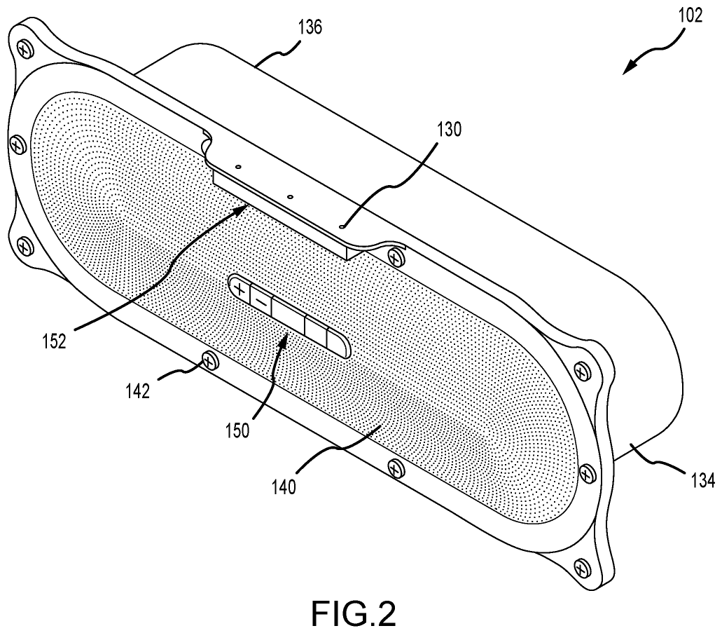

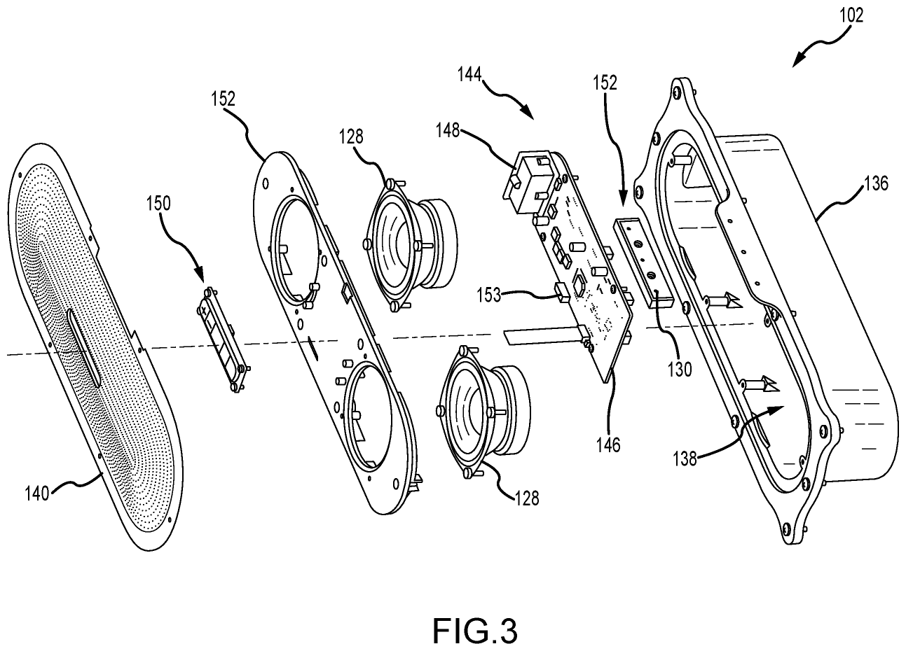

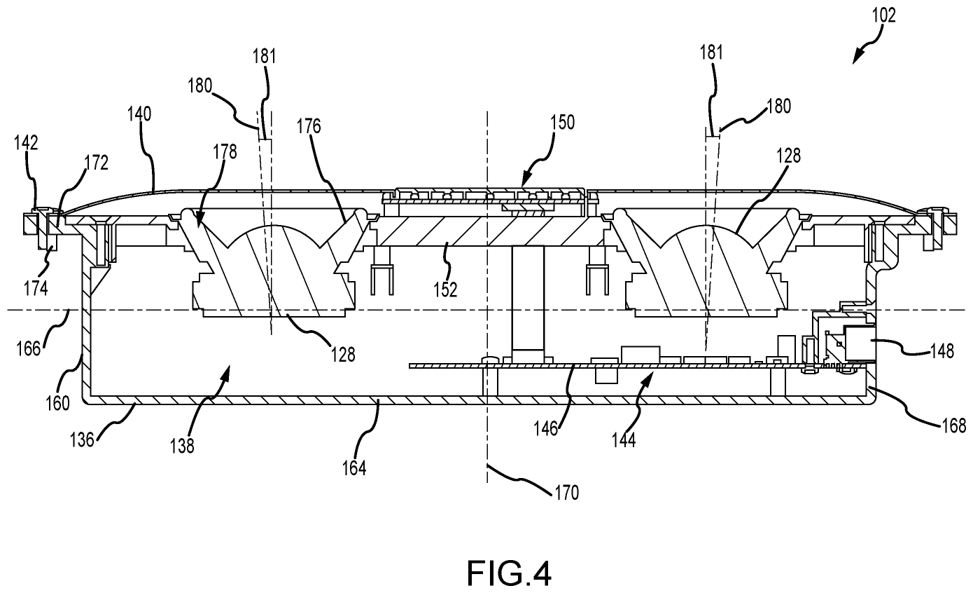

The electronic module 102 includes at least one speaker 128 (shown in FIG. 3) and one or more microphones 130 (shown in FIG. 2) that enable user interaction with the electronic module 102. In the example, when the electronic module 102 is mounted to the bed 100, the speakers 128 are oriented in a direction towards the floor surface so that sound waves 132 are also directed towards the floor surface. In contrast, the microphones 130 are oriented in a direction that is substantially parallel to the floor surface and substantially orthogonal to the direction of the speakers 128. This orientation of the components of the electronic module 102 enables the module to be mounted underneath the bed 100 while still enabling sound to be expelled from the system for the user to hear and the system to receive audio input from the user for control of the virtual assistant without interference from the sound generated by the speakers 128. The orientation of the speakers 128 and the microphones 130 are described further below in reference to FIGS. 4 and 8, respectively.

The head rail 114 at least partially defines a head section of the frame 104, while the foot rail at least partially defines a foot section of the frame 104. In one aspect, the head section may be approximately half of the bed 100, while the foot section is approximately the other half of the bed 100. In another aspect, the head section may be approximately a third of the bed 100, while the foot section is approximately a third of the bed 100, and the remaining third is a middle section. The term “head” generally refers to the part of the bed 100 that a headboard is positioned against and where a user positions one's head. The term “foot” generally refers to the part of the bed that a footboard is positioned against and where a user positions one's feet.

In the example, the electronic module 102 is disposed within the head section of the bed 100 with the microphones 130 oriented in a direction towards the foot section. The electronic module 102 can be offset from the head rail 114. For example, the electronic module 102 may be mounted within the first channel 126 formed by the rails 118 and proximate the head rail 114. It should be appreciated, however, that the electronic module 102 can be coupled to any channel 126 within the bed frame 104 as required or desired. Additionally, the electronic module 102 can be offset from both of the side beams 116 and positioned approximately in the middle of the bed 100. The position of the electronic module 102 at the head section of the frame 104 facilitates more efficient use when the user is using the module 102 on the bed 100, since the user's head is generally within the head section of the bed 100. The speakers 128 can generate audible sounds, for example, an alarm or music, that are clearly audible for the user, while the microphones 130 are oriented to clearly pick up voice controls from the user without interference from the sound generated from the speakers 128. Also, because the microphones 130 are directed towards the foot section of the bed 100, the microphones 130 pickup sound from many different locations around the bed 100. Additionally, this position of the electronic module 102 underneath the bed 100 visually hides the module 102 from the user.

Additionally, the electronic module 102 may be coupled in communication to one or more lightstrips 131 attached to at least a portion of the frame 104. The coupling may be wired or wireless (e.g., WiFi, Bluetooth, etc.), as required or desired. The lightstrip 131 may include a plurality of light emitting diodes “LEDs” and can be used to provide visual feedback to the user during operation of the electronic module 102. For example, a cyan light is generated when the electronic module 102 is listening, alternating cyan and blue lights are generated when the module 102 is thinking, pulsing cyan and blue lights are generated when the module 102 is talking, a pulsing cyan light is generated when the module 102 is timed out, a red light is generated when the module 102 is in privacy mode, a pulsing white light is generated when the module 102 is being paired, a flashing white light is generated when the module 102 is connecting/disconnected, the opacity of the light can change depending on the speaker volume, and/or a flashing white light is generated when the module 102 is muted. Because the electronic module 102 is disposed underneath the bed 100, the additional lightstrips 131 assist in providing feedback to the user since the module 102 is not visible itself. Additionally or alternatively, the lightstrips 131 can be used for an ambient light source in the room that the bed 100 is within.

FIG. 2 is a perspective view of the smart electronic module 102. FIG. 3 is an exploded perspective view of the smart electronic module 102. Referring concurrently to FIGS. 2 and 3, the electronic module 102 includes a housing 134 sized and shaped to disposed at least partially within the channel 126 of the bed 100 and supported by a pair of intermediate rails 118 (all shown in FIG. 1). The housing 134 includes a cabinet 136 that defines a single interior cavity 138 and a cover grille 140. The cover grille 140 can be coupled to the cabinet 136 by one or more fasteners 142. These fasteners 142 can also be used to mount the electronic module 102 to the bed 100. The at least one speaker 128 includes a pair of speakers disposed within the housing 134 and supported by the cabinet 136.

The electronic module 102 also includes a controller 144 that has a printed circuit board (PCB) 146 with a number of electronic/electrical components which enable operation of the electronic module 102 as described herein. For example, communication modules for wired or wireless communication, drivers for speakers and microphones, amplifier, sensors, etc. Coupled to the PCB 146 are a plurality of input and/or output ports 148 (e.g., USB(s), coaxial DC jack for external AC adaptor, etc.). Additionally, communicatively coupled to the PCB 146 is a button assembly 150 that is accessible through the cover grille 140. The button assembly 150 can include one or more buttons (e.g., power, volume up, volume down, mute, Bluetooth, etc.) and one or more LEDs that backlights the buttons. The button assembly 150 can facilitate manual operation of the electronic module 102 by the user via inputs other than voice controls, and the LEDs may provide feedback to the user and generate lighting conditions as described above in reference to the lightstrips 131 (shown in FIG. 1). The button assembly 150 is supported within the housing 134 by a panel 152.

In an aspect, the controller 144 enables the electronic module 102 to communicate with an application enabled user device, such as a computer, a smart phone, and the like. This allows users to also control the electronic module 102 as required or desired. In the example, a humidity and temperature sensor 153 is coupled to the PCB 146. The sensor 153 monitors humidity and/or temperature at the electronic module 102 with measurements that can be sent to the user device. The sensor element of the sensor 153 can be positioned underneath the cover grille 140 and on the panel 152. In some examples, the sensor 153 is used to monitor environmental conditions at the electronic module 102 and to send an alarm or warning to the user device upon reaching a predetermined monitoring threshold. For example, upon reaching a temperature of approximately 90° F. and/or a humidity of approximately 80%, the sensor 153 can send the alarm or warning to the user device. In another example, the humidity baseline for notification may be between approximately 30% and 60%. In still another example, the humidity baseline for notification may be between approximately 40% and 50%. It should be appreciated that the monitoring thresholds can be above or below the examples listed above as required or desired, and additionally, the thresholds can be modified and customized by the user. By enabling environmental conditions to be monitored, the electronic module 102 can be used, for example, in hospitality areas, to monitor water leaks, bathtub overflows, or other area conditions that change the humidity or temperature of the area around the bed and that are desirable to address relatively quickly.

A microphone module 154 includes one or more microphones 130 and is supported on an exterior of the housing 134 and outside of cover grille 140 relative to the interior cavity 138. The microphones 130 are oriented in a direction away from the speakers 128. In the example, by disposing the speakers 128 within the housing 134 and the microphones 130 outside of the housing 134, as well as, orienting the two components in directions that are away from each other, the ability for the electronic module 102 to produce quality sound when mounted to the bed and for the module 102 to pick up the user's voice is increased, thereby increasing the performance of the electronic module 102.

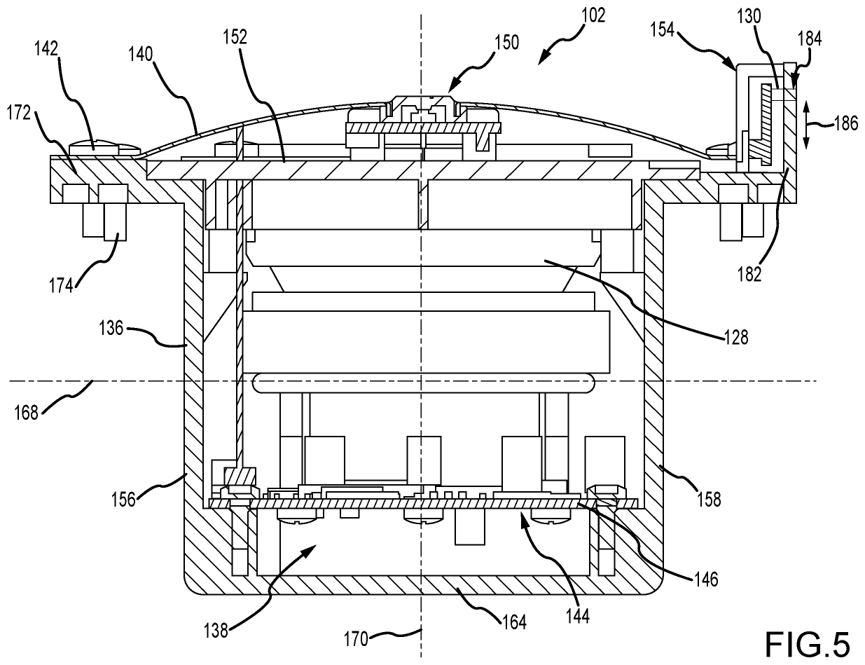

FIG. 4 is a longitudinal cross-sectional view of the smart electronic module 102. FIG. 5 is a transverse cross-sectional view of the smart electronic module 102. Referring concurrently to FIGS. 4 and 5, certain components are described above, and thus, are not necessarily described further. The cabinet 136 includes two opposing elongate walls 156, 158, two opposing transverse walls 160, 162, and a base wall 164, that define the interior cavity 138 of the cabinet 136. As described herein, a longitudinal axis 166 is defined as being substantially parallel to the elongate walls 156, 158 and substantially orthogonal to the transverse walls 160, 162. A transverse axis 168 is defined as being substantially parallel to the transverse walls 160, 162 and substantially orthogonal to the elongate walls 156, 158. Additionally, a vertical axis 170 is defined as being substantially orthogonal to both the longitudinal axis 166 and the transverse axis 168, and substantially orthogonal to the base wall 164 and substantially parallel to elongate walls 156, 158 and the transverse walls 160, 162.

Extending outwardly from the elongate walls 156, 158 and the transverse walls 160, 162 and on the opposite end from the base wall 164, a mounting flange 172 extends around the perimeter of the interior cavity 138. The mounting flange 172 is substantially parallel to the longitudinal axis 166 and the transverse axis 168, and substantially orthogonal from the walls 156-162. The mounting flange 172 is configured to mount to an underside of the pair of rails 118 of the bed 100 as illustrated in FIG. 1 via one or more fasteners 174. More specifically, the mounting flange 172 can mount to a lower row of the rails 118 while the cabinet 136 is adjacent to an upper row of the rails 118. As such, the speakers 128 are directed towards the floor surface and the cabinet 136 is supported at least partially between the rails 118. The electronic module 102 is mounted to the bed 100 so that vibration of the electronic module 102 against the rails is restricted or prevented. Additionally, the mounting flange 172 is used to support the cover grille 140.

The pair of speakers 128 are spaced apart from one another along the longitudinal axis 166 and include a cone 176 that has a concave surface 178 that opens in the vertical axis 170 direction so that the speakers 128 can open towards the floor surface when mounted to the bed frame. The pair of speakers 128 can be used to generate stereophonic sound with left and right speakers and create the impression of sound emanating from various directions from within the room. In the example, each speaker 128 has an axis 180 that is angled 181 relative to the vertical axis and in a direction towards the adjacent transverse wall 160, 162. In an aspect, the angle 181 is between about 1° and 30°. In another aspect, the angle 181 is between about 10° and 20°. In yet another aspect, the angle 181 is about 15°. By angling the speakers 128 to the left and right, respectively, within the electronic module 102, when the module 102 is mounted within the bed 100, the sound generated from the speakers 128 is directed in a direction towards the side beams 116 (shown in FIG. 1) and out from under the bed so that the user can more clearly hear the electronic module 102. The sound generated from the speakers 128 and the orientation of the speakers 128 may also enable the sound waves to deflect off the floor surface while traveling out from under the bed 100. Additionally, the speakers 128 are angled in a direction away from the microphone module 154 so as to restrict or prevent the microphones 130 from picking up the sounds generated by the speakers 128 and increase voice control performance. In another example, the speaker axis 180 may be substantially parallel to the vertical axis 170.

The speakers 128 can be electroacoustic transducer drivers that convert an electrical audio signal into a corresponding sound wave. In an aspect, the speakers 128 are dynamic speakers. In another aspect, the speakers 128 are mid-high frequency drivers. With the speakers 128 enabling mid-high frequencies and the bed 100 itself creating a sub-woofer effect for mid-low frequencies. The combination of the bed 100 and electronic module 102 forms a system that is capable of generating a full range of audio frequencies, thereby increasing audio performance for the user.

In the example, the speaker axis 180 is angled only in one direction and is still substantially parallel to the elongate walls 156, 158. Additionally or alternatively, however, the speaker axis 180 may be angled relative to the vertical axis and in a direction towards the elongate wall 156 that is opposite of the microphone module 154. For example, between about 1° and 30°. In some examples, the speaker axis 180 may be angled relative to the vertical axis in a combination of two directions, both the transverse wall 160, 162 direction and the elongate wall 156 direction. By further angling the speakers 128 in a direction away from the microphone module 154, the sound waves generated by the speakers 128 are directed around the head rail of the bed. Additionally, the microphones 130 are further restricted or prevented from picking up the sounds generated by the speakers 128 to increase voice control performance.

The cabinet 136 is a rigid closed back cabinet and the elongate walls 156, 158, the transverse walls 160, 162, and base wall 164 are devoid of any openings. In the example, the interior cavity 138 of the cabinet 136 may be approximately one-liter in volume. The cabinet 136 is configured to prevent sound wave emanating from the back of the speakers 128 from interfering destructively with those from the front. Additionally, the panel 152 can act as a baffle so that sound frequencies from the back of the speakers 128 can be canceled out.

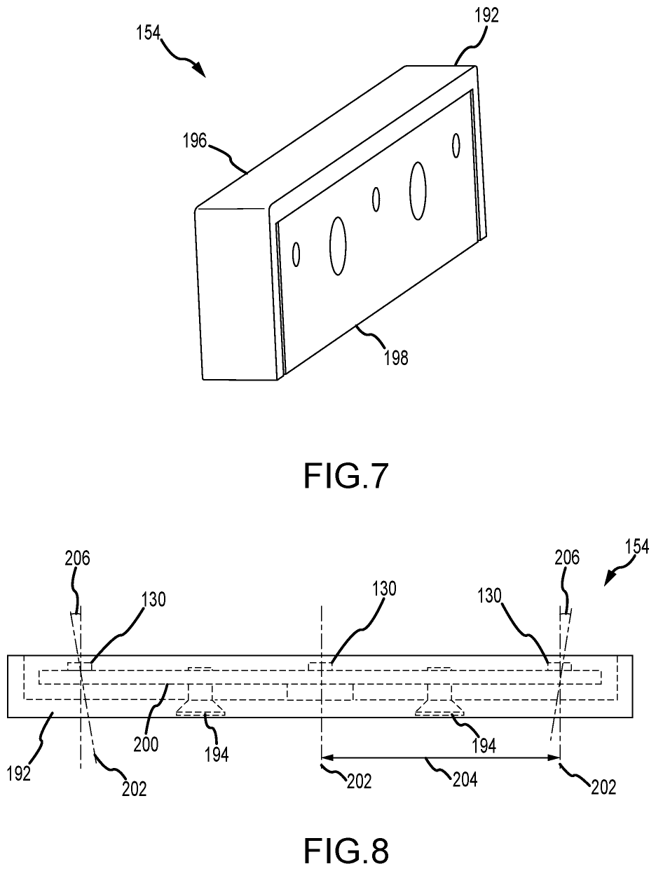

A microphone flange 182 extends from the mounting flange 172 and is configured to support the microphone module 154. The microphone flange 182 is substantially parallel to the elongate walls 156, 158 and coupled to the wall 158. The microphone flange 182 is also oriented substantially parallel to the vertical axis 170 and the longitudinal axis 166, and substantially orthogonal to the transverse axis 168. The flange 182 has a plurality of apertures 184 that align with the microphones 130 within the microphone module 154. The microphones 130 are offset 186 from the mounting flange 172 so that when the electronic module 102 is coupled to the bed 100 (shown in FIG. 1), the microphone flange 182 extends in a direction towards the floor surface and the microphones 130 are disposed below the lower row 120 of rails 118 (both shown in FIG. 1). In an aspect, the offset 186 is about 35 millimeters. This position enables the microphones 130 to more efficiently capture sound waves for control of the module 102. The microphone module 154 is described further below in reference to FIGS. 7 and 8.

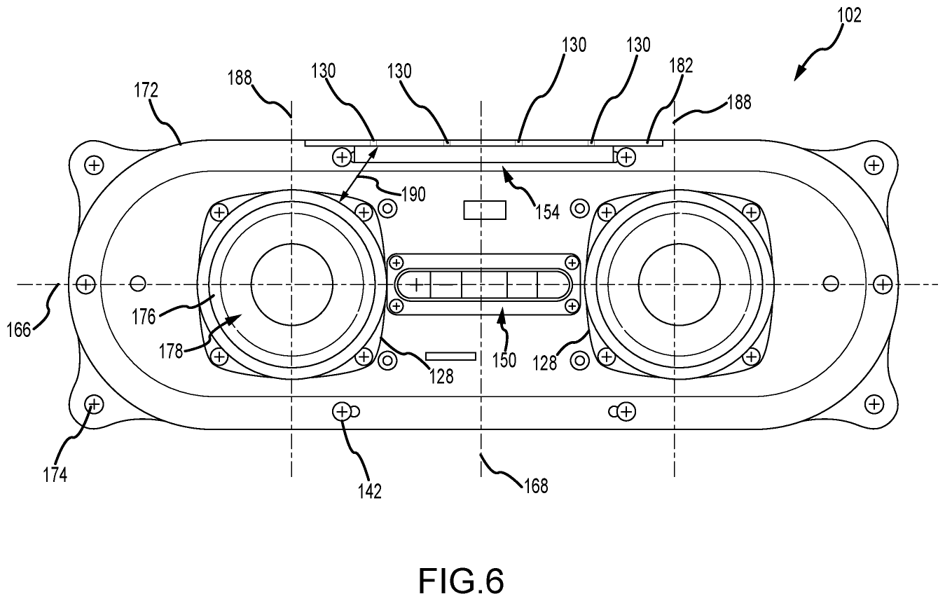

FIG. 6 is a vertical end view of the smart electronic module 102 with the cover grille 140 (shown in FIG. 2) not illustrated for clarity. Certain components are described above, and thus, are not necessarily described further. The pair of speakers 128 are spaced apart along the longitudinal axis 166 and substantially symmetrical about the transverse axis 168. Each speaker 128 also includes a cross-sectional plane 188 that extends through the speaker axis 180 (shown in FIG. 4) and substantially parallel to the transverse axis 168. In an aspect, the spacing between the cross-sectional planes 188 can be approximately 160 millimeters. The microphones 130 are disposed between the cross-sectional planes 188 of each of the pair of speakers 128. The microphones 130 can also be spaced apart along the longitudinal axis 166 and substantially symmetrical about the transverse axis 168. The microphones 130 are substantially oriented along the transverse axis 168 and away from the speakers 128, and when the electronic module 102 is mounted within the bed 100 (shown in FIG. 1), the transverse axis 168 is substantially parallel to the floor surface.

The cone 176 of each speaker 128 has a diameter such that the cone 176 overlaps with at least one microphone 130 along the longitudinal axis 166 direction. In the example, the microphones 130 are spaced 190 at least 25 millimeters from the cone 176. In an aspect, the spacing 190 between the microphone 130 and the cone 176 is about 28.5 millimeters. Additionally, the positioning ratio of the offset 186 (shown in FIG. 5) that the microphones are below the speakers 128 and the horizontal spacing 190 is about 1:0.75. This orientation and positioning restricts or prevents the microphones 130 from picking up the sounds generated by the speakers 128 so that the user can more easily provide voice controls while the electronic module 102 is positioned underneath the bed 100. That is, the sound waves generated from the speakers 128 are not competing with the sound waves being picked up by the microphones 130 so that voice control can be provided while music or other sounds are being generated by the electronic module 102.

FIG. 7 is a perspective view of the microphone module 154. FIG. 8 is a vertical end view of the microphone module 154. Referring concurrently to FIGS. 7 and 8, the microphone module 154 includes a housing 192 in which the microphones 130 are disposed within. In FIG. 8 the housing 192 is illustrated as transparent so that the components contained therein are shown. The housing 192 is configured to be secured to the microphone flange 182 of the cabinet 136 (both shown in FIG. 5) by one or more fasteners 194. The housing 192 includes a cover portion 196 and a rubber portion 198. The cover portion 196 forms a sound barrier with respect to the speakers 128 (shown in FIG. 6). The rubber portion 198 is positioned against the microphone flange 182 when the microphone module 154 is coupled to the cabinet 136 and can be used to reduce vibration of the microphones 130. Disposed within the housing 192 is a PCB 200 that the microphones 130 are coupled to. Each microphone 130 can be disposed within an airtight seal so as to reduce or prevent vibration thereof. The microphones 130 are configured to convert sound waves (e.g., from a user) into an electrical signal so that the electronic module can be controlled via voice. In an aspect, the microphones 130 are far-field microphones with beam forming technology so that the electronic module 102 (shown in FIG. 1) can pick up sounds from across a room while music is playing from the speakers.

As illustrated, there are three microphones 130 equally spaced 204 within the microphone module 154 and along the longitudinal axis 166 (shown in FIG. 6). It should be appreciated that any other number of microphones 130 may be used as required or desired. In one example, four microphones 130 may be used and equally spaced within the microphone module 154. Four microphones 130 are illustrated in FIG. 6 that is described above. Each microphone 130 has a microphone axis 202 that is substantially aligned along the transverse axis 168 (shown in FIG. 6) so as to be directed to receive sound waves that travel underneath the bed and from the foot section. In an aspect, the microphones 130 are spaced 204 apart from one another with a center-to-center distance of approximately 30 millimeters or greater.

In the example, one microphone 130 has its axis 202 as being different than an axis 202 of another microphone 130. This enables the microphone module 154 to more efficiently pick up sounds coming from different areas around the bed 100 (shown in FIG. 1). The left and right microphones 130 have their axes 202 angled 206 relative to the transverse axis 168 (shown in FIG. 6) in two different directions (e.g., down and out directions). The angle 206 is first in a direction outwards towards the adjacent transverse wall 160, 162 (shown in FIG. 4). By angling the outside microphones 130 to the left and right, respectively, within the electronic module 102, when the module 102 is mounted within the bed 100, the microphones 130 can receive sounds generated from a direction along the side beams 116 (shown in FIG. 1) of the bed 100. Additionally, the angle 206 is also secondly in a direction downward away from the cabinet 136 (shown in FIG. 5). By angling the outside microphones 130 downward (e.g., in a direction towards the floor surface when the electronic module 102 is mounted within the bed 100 and in-and-out of the page illustrating FIG. 8), the microphones 130 can receive sounds that deflect off of the floor surface and come in from under the bed 100.

In an aspect, the angle 206 is between about 1° and 50° relative to both directions as described above. In another aspect, the angle 206 is between about 15° and 35° relative to both directions. In yet another aspect, the angle 206 is about 25° relative to both directions. In still another aspect, the angle 206 may be different in both directions (e.g., 20° down and 25° out). It should be appreciated, that in other examples, the microphone axis 202 may be angled 206 in one direction, either only outwards toward the adjacent transverse wall 160, 162 or only downwards away from the cabinet 136. In another example, the microphone axis 202 may be substantially parallel to the transverse axis 168.

Additionally, the middle microphone 130 has its axis 202 angled relative to the transverse axis 168 only in one direction (e.g., down direction and in-and-out of the page illustrating FIG. 8). The angle is in a direction downward and away from the cabinet 136. By angling the middle microphone 130 downward (e.g., in a direction towards the floor surface when the electronic module 102 is mounted within the bed 100), the microphone 130 can receive sounds that deflect off of the floor surface and come in from under the bed 100 from the foot section. In an aspect, the angle is between about 1° and 50° relative to the downward directions as described above. In another aspect, the angle is between about 15° and 35° . In yet another aspect, the angle is about 25° . It should be appreciated, that in other examples, the microphone axis 202 of the middle speaker may be angled in two directions, both outwards towards the transverse walls 160, 162 and downwards away from the cabinet 136. In another example, the microphone axis 202 of the middle microphone may be substantially parallel to the transverse axis 168.

In examples where four microphones are used, the two middle microphones 130 may be oriented in similar directions and as described above. In other examples, the two middle microphones 130 may be oriented in different directions as required or desired.

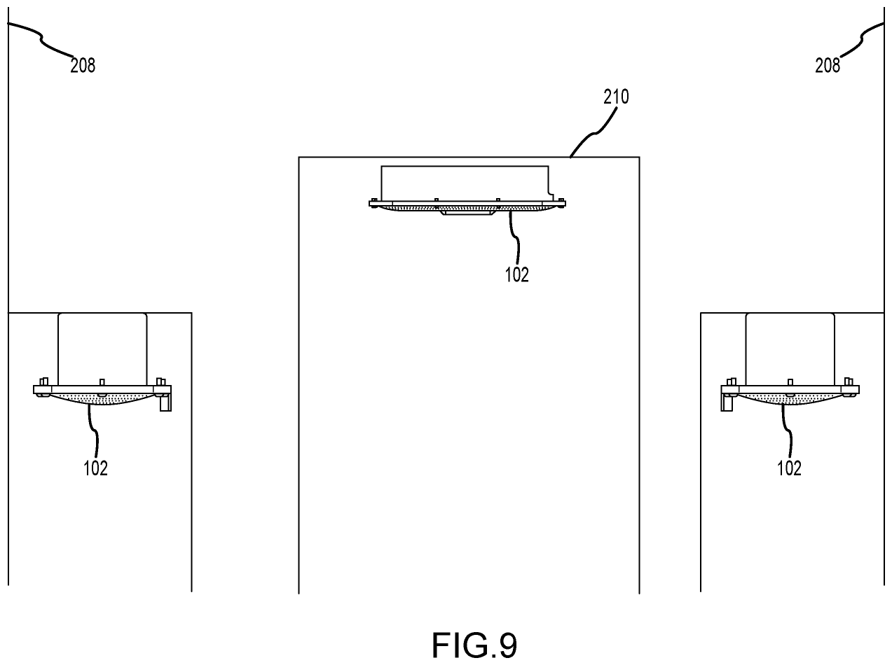

FIG. 9 is a schematic view of the smart electronic module 102 coupled to other furniture pieces. It is appreciated that while in FIG. 1 the smart electronic module 102 is described as being mounted to a bed, the electronic module 102 can be mounted to any other piece of furniture as required or desired. For example, the electronic module 102 may be mounted to a chair 208 or a table 210. In other examples, any other furniture piece may be used, such as, but not limited to, stools, sofas, coffee tables, cupboards, shelves, dressers, desks, nightstands, TV stands, ottomans, kitchen islands, pool and other game tables, storage cabinets, etc. In an aspect, the electronic module 102 is mounted to DUX® furniture, such as, but not limited to sofas, armchairs, and tables. As described above, the electronic module 102 is configured to be positioned underneath and out of the way on the furniture. The speakers and microphones are arranged to increase the performance of the electronic module 102 while positioned underneath the furniture.

Notwithstanding the appended claims, and in addition to the examples described above, further examples are disclosed in the following numbered clauses:
1. A bed comprising:
   a frame including a plurality of rails and a plurality of legs, wherein a pair of rails of the plurality of rails form a channel therebetween, and wherein the plurality of legs positions the plurality of rails above a floor surface; and
   an electronic module coupled to the frame, the electronic module including:
      a housing configured to be disposed at least partially within the channel and supported by the pair of rails;
      a pair of speakers disposed within the housing, wherein each of the pair of speakers include a cone that has a concave surface that opens in a direction towards the floor surface; and
      one or more microphones supported on an exterior of the housing, wherein the one or more microphones are oriented in a direction away from the pair of speakers.
2. The bed of clause 1, wherein the housing includes a cabinet that defines a single interior cavity and a cover grille, wherein the pair of speakers are disposed within the single interior cavity.
3. The bed as in any preceding clause, wherein the pair of speakers are spaced apart from one another, and each of the pair of speakers include a cross-sectional plane that are substantially parallel to one another, and wherein the one or more microphones are disposed between the cross-sectional planes of each of the pair of speakers.
4. The bed as in any preceding clause, wherein the housing includes a cabinet having two opposing elongate walls and two opposing transverse walls, wherein at least one of the two opposing elongate walls has a first flange extending substantially parallel therefrom, and wherein the first flange supports the one or more microphones.
5. The bed as in any preceding clause, wherein each of the two opposing elongate walls and the two opposing transverse walls have a second flange extending substantially orthogonal therefrom, and wherein the second flange is configured to couple to the pair of rails.
6. The bed as in any preceding clause, wherein the frame includes a head section and a foot section, and wherein the electronic module is disposed within the head section.
7. The bed as in any preceding clause, wherein the one or more microphones are oriented in a direction towards the foot section.
8. The bed as in any preceding clause, wherein the plurality of rails include two rows of rails, and wherein the housing extends between both of the two rows of rails.
9. The bed as in any preceding clause, further comprising at least one lightstrip attached to at least a portion of the frame and coupled in communication to the electronic module.
10. An electronic module for furniture, the electronic module comprising:
   a housing including:
      a cabinet having two elongate walls, two transverse walls, and a base wall forming an interior cavity, wherein a first axis is substantially parallel to the two elongate walls and the two transverse walls;
      a flange coupled to at least one of the two elongate walls and substantially parallel to the first axis; and
      a cover grille;
   a pair of speakers disposed within the interior cavity and oriented in a direction that is substantially parallel to the first axis; and
   a microphone module coupled to the flange and positioned outside of the interior cavity, wherein the microphone module includes one or more microphones, wherein a second axis is orthogonal to the first axis, and wherein the one or more microphones are substantially oriented in a direction along the second axis and away from the pair of speakers.
11. The electronic module of clause 10, wherein the one or more microphones includes four microphones equally spaced along the flange.
12. The electronic module as in any of clauses 10 or 11, wherein a first microphone of the four microphones has an axis that is different than an axis of a second microphone of the four microphones.
13. The electronic module as in any of clauses 10-12, wherein the axis of the first microphone is angled approximately 25° from the second axis in two directions, and the axis of the second microphone is angled approximately 25° from the second axis in a single direction.
14. The electronic module as in any of clauses 10-13, wherein a third axis is orthogonal to both the first axis and the second axis, and the pair of speakers are spaced apart along the third axis, wherein each speaker of the pair of speakers includes a cone, and wherein the one or more microphones overlap within the cone along the third axis.
15. The electronic module as in any of clauses 10-14, wherein the one or more microphones are spaced at least 25 millimeters from the cone.
16. The electronic module as in any of clauses 10-15, wherein each speaker of the pair of speakers are angled approximately 15° from the first axis and in directions that are opposite of one another.
17. The electronic module as in any of clauses 10-16, wherein the cabinet is a closed back cabinet.
18. The electronic module as in any of clauses 10-17, wherein the flange is a first flange and the housing further includes a second flange extending from the two elongate walls and the two transverse walls and substantially parallel to the second axis, and wherein the second flange is configured to couple to two rails of a bed frame.
19. The electronic module as in any of clauses 10-18, wherein the one or more microphones are offset from the second flange.
20. The electronic module as in any of clauses 10-19, further comprising a humidity sensor.
21. A bed comprising:
   a frame including two stacked rows of rails, each row having a plurality of rails, wherein a pair of rails of each row form a channel therebetween, and wherein the channel is raised above a floor surface by the frame; and
   a smart electronic module configured to enable a voice-controlled intelligent virtual personal assistant, wherein the smart electronics module includes:
      a cabinet defining an interior cavity and having a first flange extending therefrom, wherein the first flange is coupled to the pair of rails on a lower row of the two stacked rows and the cabinet is disposed at least partially within the channel and adjacent the pair of rails on an upper row of the two stacked rows;
      a pair of speakers disposed within the interior cavity and directed in a first direction towards the floor surface; and
      a plurality of microphones supported on a second flange, wherein the second flange extends from the cabinet and in the first direction towards the floor surface, and wherein the plurality of microphones are oriented along a second direction that is substantially parallel to the floor surface.
22. The bed of clause 21, wherein the plurality of microphones are disposed below the lower row of rails.
23. The bed as in any of clauses 11 or 22, wherein the pair of speakers and the plurality of microphones are symmetrically spaced about a transverse axis of the smart electronics module.
24. The bed as in any of clauses 21-23, wherein the frame is wood.
25. A bed comprising:
   a frame at least partially raised above a floor surface; and
   a smart electronic module configured to enable a voice-controlled intelligent virtual personal assistant, wherein the smart electronics module includes:
      a cabinet defining an interior cavity and having a first flange extending therefrom, wherein the first flange is coupled to the frame and the cabinet is disposed at least partially within the within the frame;
      a pair of speakers disposed within the interior cavity and directed in a first direction towards the floor surface; and
      a plurality of microphones supported on a second flange, wherein the second flange extends from the cabinet and in the first direction towards the floor surface, and wherein the plurality of microphones are oriented along a second direction that is substantially parallel to the floor surface.
26. The bed of clause 25, wherein the smart electronic module is disposed within a head section of the bed.
27. The bed as in any of clauses 25 or 26, further comprising at least one lightstrip attached to at least a portion of the frame.

It is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. It must be noted that, as used in this specification, the singular forms “a,” “an,” and “the” include plural referents unless the context clearly dictates otherwise.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified examples and examples. In this regard, any number of the features of the different examples described herein may be combined into one single example and alternate examples having fewer than or more than all of the features herein described are possible.

While various examples have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. A bed comprising:
a frame including a plurality of rails and a plurality of legs, wherein a pair of rails of the plurality of rails form a channel therebetween, and wherein the plurality of legs positions the plurality of rails above a floor surface; and
an electronic module coupled to the frame, the electronic module including:
a housing configured to be disposed at least partially within the channel and supported by the pair of rails;
a pair of speakers disposed within the housing, wherein each of the pair of speakers include a cone that has a concave surface that opens in a direction towards the floor surface; and
one or more microphones supported on an exterior of the housing, wherein the one or more microphones are oriented in a direction away from the pair of speakers.

2. The bed of claim 1, wherein the housing includes a cabinet that defines a single interior cavity and a cover grille, wherein the pair of speakers are disposed within the single interior cavity.

3. The bed of claim 1, wherein the pair of speakers are spaced apart from one another, and each of the pair of speakers include a cross-sectional plane that are substantially parallel to one another, and wherein the one or more microphones are disposed between the cross-sectional planes of each of the pair of speakers.

4. The bed of claim 1, wherein the housing includes a cabinet having two opposing elongate walls and two opposing transverse walls, wherein at least one of the two opposing elongate walls has a first flange extending substantially parallel therefrom, and wherein the first flange supports the one or more microphones.

5. The bed of claim 4, wherein each of the two opposing elongate walls and the two opposing transverse walls have a second flange extending substantially orthogonal therefrom, and wherein the second flange is configured to couple to the pair of rails.

6. The bed of claim 1, wherein the frame includes a head section and a foot section, and wherein the electronic module is disposed within the head section.

7. The bed of claim 6, wherein the one or more microphones are oriented in a direction towards the foot section.

8. The bed of claim 1, further comprising at least one lightstrip attached to at least a portion of the frame and coupled in communication to the electronic module.

9. An electronic module for furniture, the electronic module comprising:
a housing including:
a cabinet having two elongate walls, two transverse walls, and a base wall forming an interior cavity, wherein a first axis is substantially parallel to the two elongate walls and the two transverse walls;
a flange coupled to at least one of the two elongate walls and substantially parallel to the first axis; and
a cover grille;
a pair of speakers disposed within the interior cavity and oriented in a direction that is substantially parallel to the first axis; and
a microphone module coupled to the flange and positioned outside of the interior cavity, wherein the microphone module includes one or more microphones, wherein a second axis is orthogonal to the first axis, and wherein the one or more microphones are substantially oriented in a direction along the second axis and away from the pair of speakers.

10. The electronic module of claim 9, wherein the one or more microphones includes four microphones equally spaced along the flange.

11. The electronic module of claim 10, wherein a first microphone of the four microphones has an axis that is different than an axis of a second microphone of the four microphones.

12. The electronic module of claim 11, wherein the axis of the first microphone is angled approximately 25° from the second axis in two directions, and the axis of the second microphone is angled approximately 25° from the second axis in a single direction.

13. The electronic module of claim 9, wherein a third axis is orthogonal to both the first axis and the second axis, and the pair of speakers are spaced apart along the third axis, wherein each speaker of the pair of speakers includes a cone, and wherein the one or more microphones overlap within the cone along the third axis.

14. The electronic module of claim 13, wherein the one or more microphones are spaced at least 25 millimeters from the cone.

15. The electronic module of claim 9, wherein each speaker of the pair of speakers are angled approximately 15° from the first axis and in directions that are opposite of one another.

16. The electronic module of claim 9, wherein the flange is a first flange and the housing further includes a second flange extending from the two elongate walls and the two transverse walls and substantially parallel to the second axis, and wherein the second flange is configured to couple to two rails of a bed frame.

17. The electronic module of claim 9, further comprising a humidity sensor.

18. A bed comprising:
a frame including two stacked rows of rails, each row having a plurality of rails, wherein a pair of rails of each row form a channel therebetween, and wherein the channel is raised above a floor surface by the frame; and
a smart electronic module configured to enable a voice-controlled intelligent virtual personal assistant, wherein the smart electronics module includes:
a cabinet defining an interior cavity and having a first flange extending therefrom, wherein the first flange is coupled to the pair of rails on a lower row of the two stacked rows and the cabinet is disposed at least partially within the channel and adjacent the pair of rails on an upper row of the two stacked rows;
a pair of speakers disposed within the interior cavity and directed in a first direction towards the floor surface; and
a plurality of microphones supported on a second flange, wherein the second flange extends from the cabinet and in the first direction towards the floor surface, and wherein the plurality of microphones are oriented along a second direction that is substantially parallel to the floor surface.

19. The bed of claim 18, wherein the plurality of microphones are disposed below the lower row of rails.

20. The bed of claim 18, wherein the pair of speakers and the plurality of microphones are symmetrically spaced about a transverse axis of the smart electronics module.
